(19) United States
(12) Patent Application Publication
(10) Pub. No.: US 2005/0120280 A1
(43) Pub. Date: Jun. 2, 2005

(54) Workflow managing method and recording medium

(75) Inventors: Chia-Yi Liang, Shindian City (TW); Andy Chen, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/982,932

(22) Filed: Nov. 8, 2004

(30) Foreign Application Priority Data
Nov. 14, 2003 (TW) 092132080

(51) Int. Cl. G06F 11/00

(52) U.S. Cl. 714/45

(57) ABSTRACT

A workflow managing method comprises the following steps. Setting at least a first terminal state, a second terminal state, and a third terminal state. Generating a first instruction, a second instruction, and a third instruction respectively corresponding to the first, second, and third terminal states. Generating a first path, a second path, and a third path respectively according to the first, second, and third instructions. The first path from the first instruction points to one of the first, second, and third terminal states. The second path from the second instruction points to one of the first, second, and third terminal states. The third path from the third instruction points to one of the first, second, and third terminal states. Furthermore, a recording medium, having a computer executable program for performing the workflow managing method, is provided.

### BACKGROUND OF THE INVENTION

1. Field of Invention

The invention relates to a workflow managing method and, in particular, to a workflow managing method that is capable of establishing flowcharts to control the progress of work or data.

2. Related Art

To improve the work efficiency and to integrate the operation procedures of different departments, one usually designs a workflow to link up all operation procedures in view of actual needs. Then, a flowchart is established for different departments, so that they can execute and control their operation procedures according to this flowchart.

A conventional flowchart for debug operation procedure will be described below with reference, to FIG. 1A. As shown in FIG. 1A, firstly a debug report generating department forwards bug-related data to the manager of the debug department (step S01). In this step S01, for example, the bug-related data could come from the customer service department or the test department, and these bug-related data are then forwarded to the debug report generating department. The debug report generating department then generates a debug request form, and forwards this debug request form to the manager of the debug department along with the bug-related data.

Then, in step S02, the manager of the debug department decides whether to accept this debug request form depending on whether the bug-related data is sufficient. If the manager does not accept the debug request form, then jump to step S03. If the manager accepts the debug report, then jump to step S04.

In step S03, when the manager of the debug department does not accept the debug request form, a reject message is returned to the debug report generating department, so that the debug report generating department can gather bug-related data again, and provide more sufficient bug-related data to the manager of the debug department.

In addition, in step S04, if the manager of the debug department accepts the debug request form, the manager forwards the accepted debug request form and the bug-related data to a debug engineer. Then, in step S05, the debug engineer begins the debug operation according to the debug request form and the bug-related data. To this point, the workflow for the whole debug operation procedure is finished. It should be noted that the above-mentioned workflow can be realized by conventional paper documents, or be realized by electronic forms using computers and network systems.

However, the above-mentioned workflow is not suitable for many reasons when being implemented practically. For example, the debug engineer cannot report to the manager when error exists in the debug request form or when the bug-related data is insufficient. This results in that the debug operation procedure could not be finished smoothly. In addition, when the debug engineer finishes the debug operation procedure, the correctness of the debug operation cannot be confirmed effectively.

Besides, since each step of the workflow shown in FIG. 1A is designed sequentially according to the original request form, one must design another workflow and flowchart all over again when the original workflow is not suitable for practical use. FIG. 1B is an example of the flowchart of a new workflow. As shown in FIG. 1B, after the manager of the debug department forwards the debug request form and the bug-related data to the debug engineer (S04), step S06 is performed. In step S06, the debug engineer decides whether to accept the debug request form depending on whether the bug-related data is sufficient. When the debug engineer feels that the bug-related data is insufficient, the workflow jumps back to step S02 so that he/she can return the debug request form to the manager. The manager then can re-confirm whether the bug-related data is sufficient. In addition, when the debug engineer confirms that the bug-related data is sufficient, then the workflow jumps to step S05 to proceed with the debug operation procedure.

Finally, in step S07, the manager of the debug department confirms the completion of the debug operation procedure. The whole debug workflow ends when the confirmation is affirmative. If the manager of the debug department has doubts about the result of the debug operation procedure, the workflow jumps back to step S01 to re-confirm the contents of the bug-related data and to run the whole debug workflow all over again.

As mentioned above, referring to FIG. 2, the conventional workflow managing method is constituted by a plurality of workflow paths 21 and work stages 22. Therefore, when revising the workflow, one must both adjust (for instance, add and delete) the workflow paths 21 and adjust (for instance, add, delete, and modify) relevant work stages 22 (such as add and delete steps S05 to S07, and rearrange the procedures between these steps). The actions required are difficult and complicated. Furthermore, after the workflow being revised, since the procedures are different, old data often becomes incompatible with new workflow, which results in the missing of the old data when one must start the new workflow and abandon the old one in the middle the debug operation procedure.

Therefore, it is a subjective to provide a workflow managing method that is capable of establishing flowcharts to control the progress of work or data more effectively, revise the procedures and integrate all data more easily.

### SUMMARY OF THE INVENTION

In view of the above, the invention is to provide a workflow managing method that can effectively control the progress of work and data.

To achieve the above, the workflow managing method according to the invention comprises the steps of:
1. at least setting a first terminal state, a second terminal state and a third terminal state;
2. at least generating a first instruction, a second instruction and a third instruction for the first terminal state, the second terminal state and the third terminal state, respectively; and
3. generating a first path, a second path and a third path respectively according to the first instruction, the second instruction and the third instruction.

In the invention, the first path is pointed from the first instruction to at least one of those terminal states, the second path is pointed from the second instruction to at least one of those terminal states and the third path is pointed from the third instruction to at least one of those terminal states.

In addition, the invention also discloses a recording medium that records the program or the program code segment for a computer to perform the above-mentioned workflow managing method.

Since the workflow managing method according to the invention set different terminal states to control the workflow, and each terminal state is designed to have at least one instruction having a corresponding path, the progress of work or data can be controlled effectively. Furthermore, the workflow managing method according to the invention can revise the workflow easily by adding, deleting and/or amending the instruction(s) inside the terminal states while the original terminal states remain unchanged. Therefore, the data can be integrated without any data loss.

### BRIEF DESCRIPTION OF THE DRAWINGS

The invention will become more fully understood from the detailed description given herein below illustration only, and thus is not limitative of the present invention, and wherein:

FIG. 1A and FIG. 1B are flowcharts showing two debug workflows in the prior art;

FIG. 2 is a schematic diagram showing the basic architecture of the workflow in the prior art;

FIG. 3A to FIG. 3C are schematic diagrams showing a workflow generated by the workflow managing method according to an embodiment of the invention;

FIG. 4 is a schematic diagram showing a debug workflow generated by the workflow managing method according to an embodiment of the invention;

FIG. 5 is a schematic diagram showing another debug workflow generated by the workflow managing method according to an embodiment of the invention; and

FIG. 6 is a schematic diagram showing the basic architecture of the workflow according to the embodiment of the invention.

### DETAILED DESCRIPTION OF THE INVENTION

The workflow managing method and recording medium according to the embodiments of the invention will be described below with reference to relevant drawings, wherein the same elements are assigned with the same reference numbers.

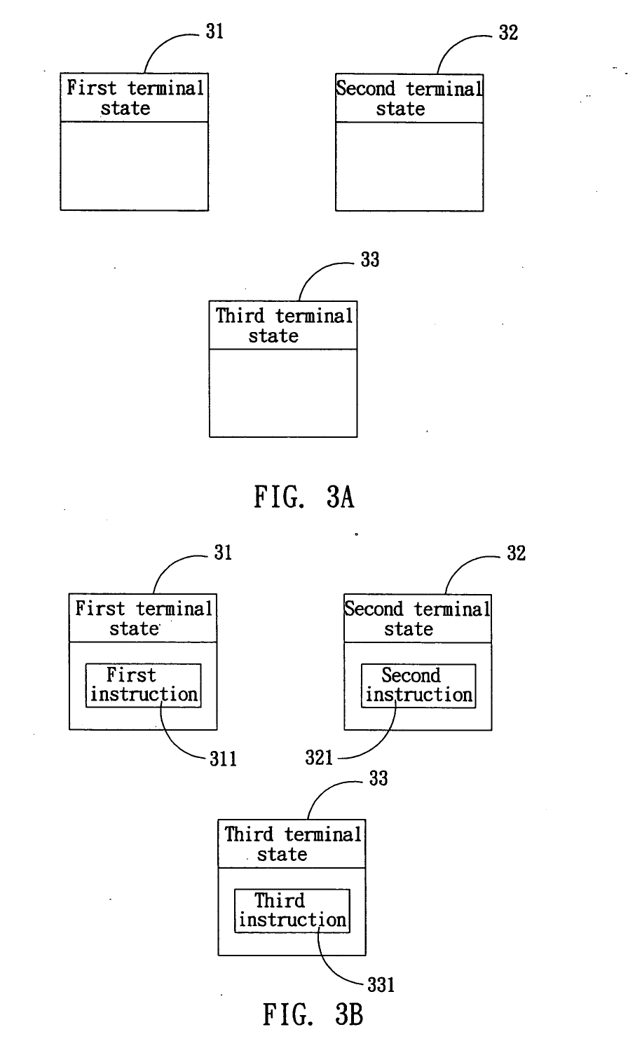

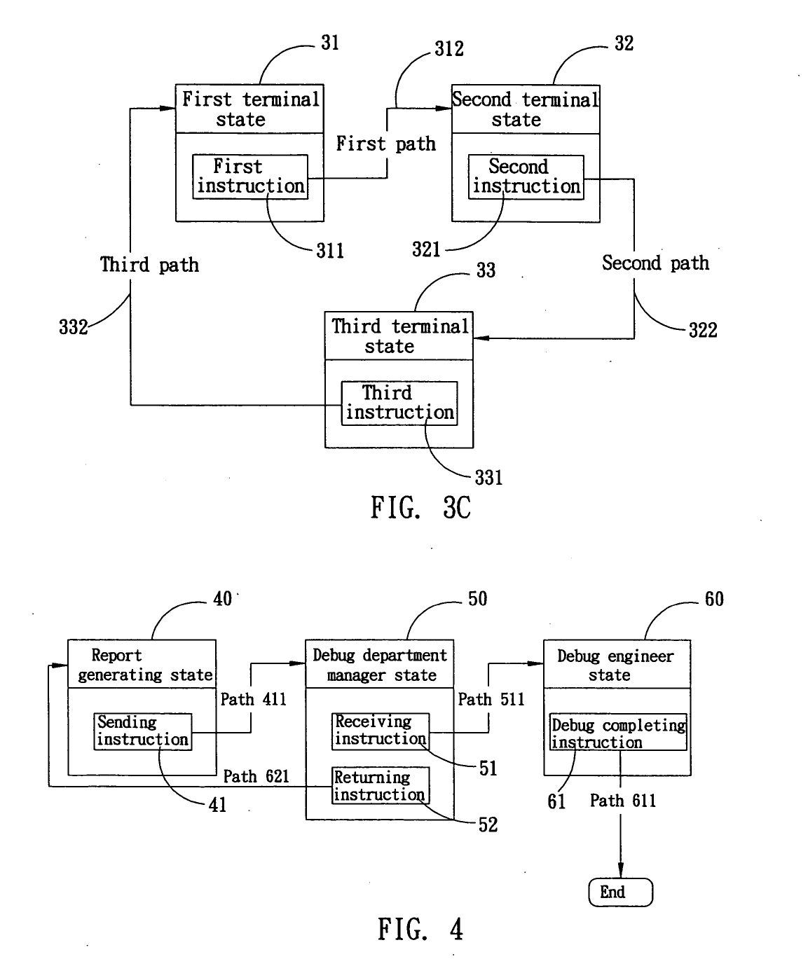

Please refer to FIGS. 3A to 3C, the workflow managing method according to one embodiment of the invention comprises the steps as described herein below.

Firstly, as shown in FIG. 3A, at least setting a first terminal state 31, a second terminal state 32 and a third terminal state 33.

Then, as shown in FIG. 3B, at least generating a first instruction 311, a second instruction 321 and a third instruction 331 according to the first terminal state 31, the second terminal state 32 and the third terminal state 33, respectively.

Finally, as shown in FIG. 3C, generating a first path 312, a second path 322 and a third path 332 respectively according to the first instruction 311, the second instruction 321 and the third instruction 331. The first path 312, the second path 322 and the third path 332 respectively points from the first instruction 311, the second instruction 321 and the third instruction 331 to at least one of the first terminal state 31, the second terminal state 32 and the third terminal state 33. In this embodiment, the first path 312 points from the first instruction 311 to the second terminal state 32, the second path 322 points from the second instruction 321 to the third terminal state 33 and the third path 332 points from the third instruction 331 to the first terminal state 31.

As mentioned above, the workflow managing method according to the embodiments of the invention cooperates with at least one user. When the user chooses to execute the first instruction 311 under the first terminal state 31, the data of the first terminal state 31 is output from the first terminal state 31 to the second terminal state 32 via the first path 312. When the user chooses to execute the second instruction 321 under the second terminal state 32, the data of the second terminal state 32 is output from the second terminal state 32 to the third terminal state 33 via the second path 322. When the user chooses to execute the third instruction 331 under the third terminal state 33, the data of the third terminal state 33 is output from the third terminal state 33 to the first terminal state 31 via the third path 332. It should be noted that each terminal state might comprise plural instructions. For example, if there has N terminal states in total, each terminal state might comprise one to several (at most N) instructions, and each instruction under any terminal state might point to one or several terminal states (at most N terminal states) separately. Of course, any instruction is capable of pointing to the terminal state it located in or other terminal(s), and the different instructions inside the same terminal state are also capable of pointing to the same one of the terminal states. Each instruction could be pointed to one terminal state or multiple terminal states depending on the instruction itself.

Besides, the workflow managing method according to another preferred embodiment might further comprise the following procedures (not shown in figures):

A terminal state adding procedure. This procedure comprises adding a fourth terminal state; generating a fourth instruction for the fourth terminal state; and generating a fourth path in accordance with the fourth instruction. In this embodiment, the fourth path points from the fourth instruction to at least one of the first terminal state, the second terminal state, the third terminal state and the fourth terminal state.

An instruction adding procedure. This procedure comprises adding a fifth instruction for one of the first terminal state, the second terminal state and the third terminal state; and generating a fifth path in accordance with the fifth instruction. In this embodiment, the fifth path points from the fifth instruction to at least one of the first terminal state, the second terminal state and the third terminal state.

A path altering procedure. This procedure comprises altering one of the paths to point to another terminal state. For example, altering the second path such that the second path is from the second terminal state to the first terminal state but not the third terminal state.

A path deleting procedure. This procedure comprises deleting one of the paths.

Furthermore, the data source of each terminal state could be obtained either from other terminal states via the paths or being inputted by the user(s).

To make the content of the invention more comprehensive, a workflow of the debug operation procedure will be described herein below as an example.

Referring to FIG. 4, three terminal states are established according to the departments involved in the whole debug operation procedure. The terminal states comprise a report generating state 40, a debug department manager state 50, and a debug engineer state 60. In this embodiment, the report generating state 40 comprises a sending instruction 41, the debug department manager state 50 comprises a receiving instruction 51 and a returning instruction 52, and the debug engineer state 60 comprises a debug completing instruction 61.

When the debug report generating department chooses to execute the sending instruction 41 under the report generating state 40, the bug-related data collected by the debug report generating department are forwarded to the debug department manager state 50 via the path 411. As mentioned above, the bug-related data are usually collected from the customer service department, test department and the likes. The operator of the debug report generating department inputs the bug-related data into the report generating state 40, so that the bug-related data could be forwarded to the debug department manager state 50.

The manager of the debug department can then choose to execute the receiving instruction 51 or the returning instruction 52 under the debug department manager state 50. In this embodiment, the manager of debug department chooses to execute the receiving instruction 51 when the bug-related data are sufficient, and the debug-related data are forwarded to the debug engineer state 60 from the debug department manager state 50 via the path 511. Alternatively, when the bug-related data are insufficient, the manager of the debug department chooses to execute the returning instruction 52, and the bug-related data and the debug request form are forwarded to the report generating state 40 via the path 521. Then, the operators of debug report generating department could collect more useful bug-related data. When the collected bug-related data are sufficient, the operators of the debug report generating department could execute the sending instruction 41 again to forward the more sufficient bug-related data to the debug department manager state 50.

Finally, when the debug engineer state 60 receives the bug-related data forwarded from the debug department manager state 50, the debug engineer executes the debug operation according to the bug-related data. When the debug operation is finished, the debug engineer chooses to execute the debug completing instruction 61 under the debug engineer state 60, and the workflow is then be pointed to the accomplishment via the path 611.

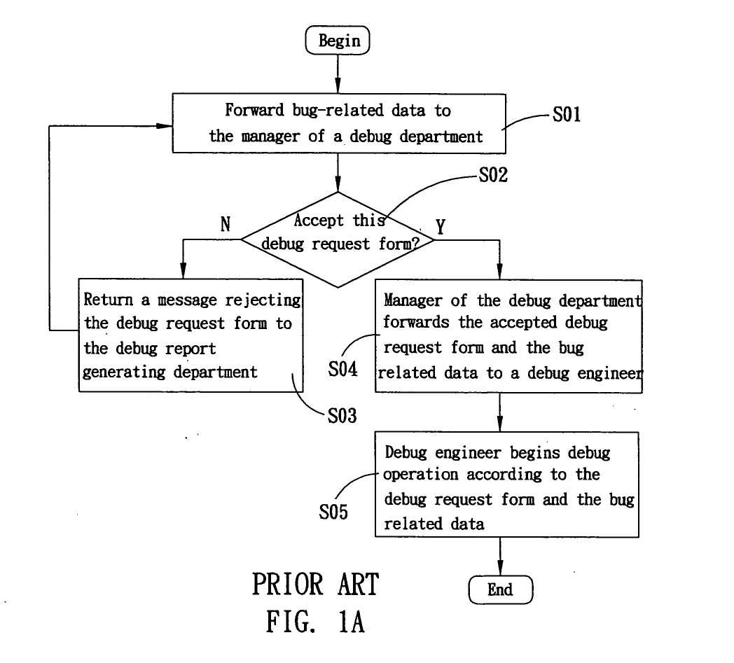

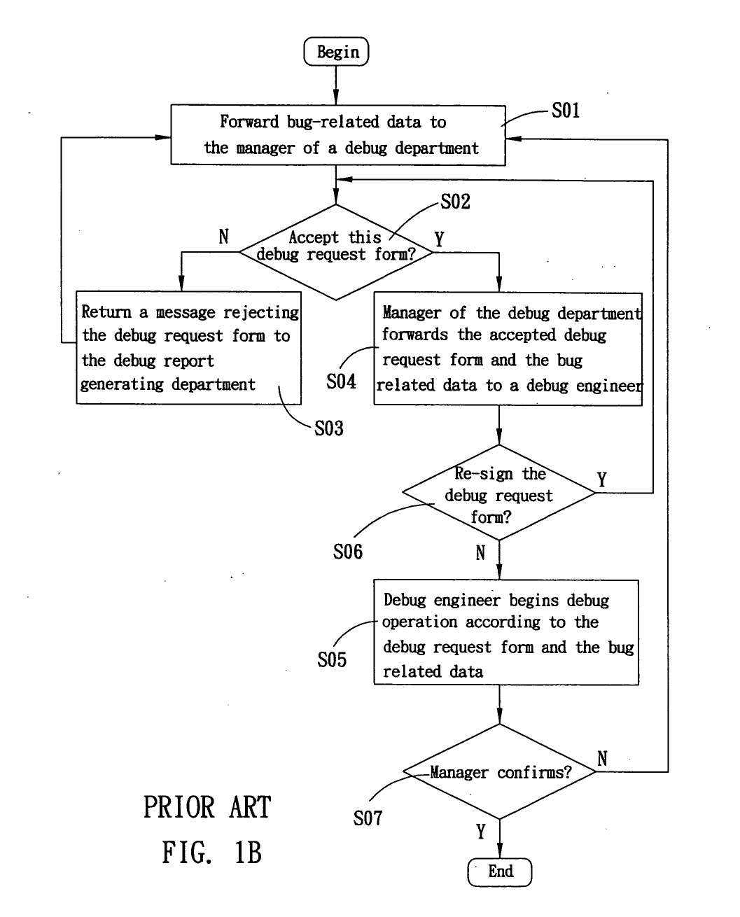

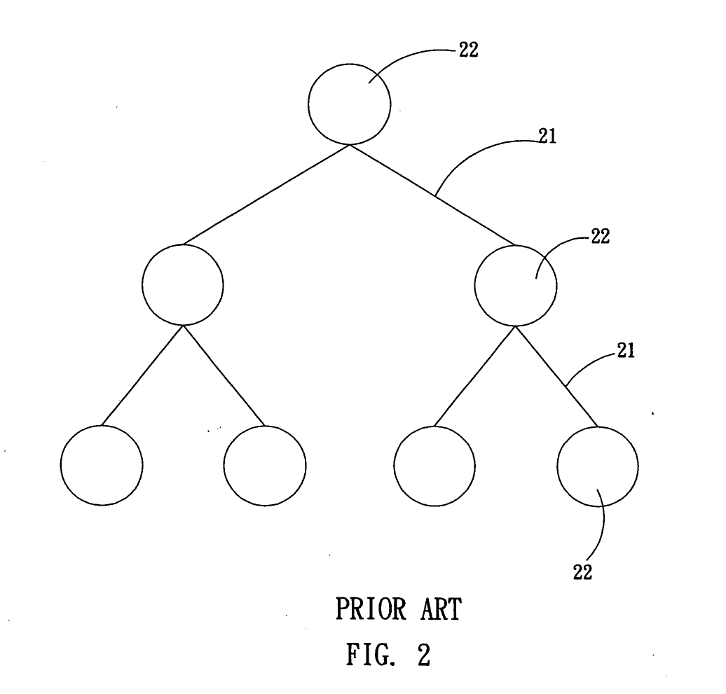

It should be noted that in the debug operation procedure of this embodiment (as shown in FIG. 4), the procedures executed by each department are the same as those in the prior art (as shown in FIG. 1A). The main framework of the debug operation procedure established according to the workflow managing method of the embodiment (as shown in FIG. 4) is designed with reference to different states of each department, so that it could control the progress of the work or the data effectively.

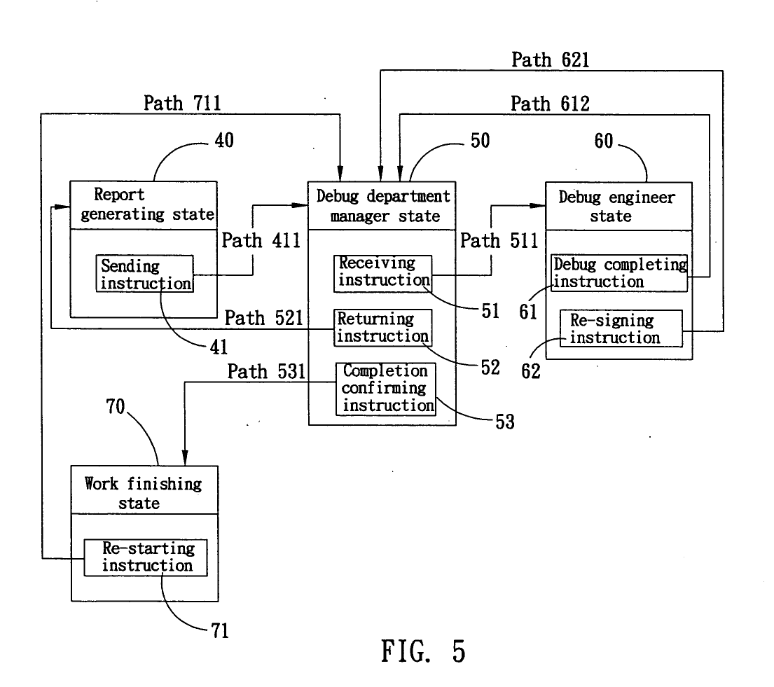

Besides, with reference to FIG. 5, when the original workflow is unsuitable, the workflow managing method of the embodiment utilizes the above-mentioned procedures, such as the terminal state adding procedure, the instruction adding procedure, the path altering procedure and the path deleting procedure, to revise the debug operation procedure.

In the present embodiment, in order for the debug engineer to feedback to the manager when the debug request form is erroneous or when the bug-related data is insufficient, a re-signing instruction 62 can be added in the debug engineer state 60, and a path 621 from the re-signing instruction 62 to the debug department manager state 50 can be generated. When the debug engineer executes the re-signing instruction 62, a message or the debug request form is forwarded to the debug department manager state 50. The manager of the debug department can examine the bug-related data again to confirm again whether to accept the bug-related data from the report generating department (to execute the receiving instruction 51), or to execute the returning instruction 52 to return the bug-related data and the debug request form to the report generating state 40 via the path 521 for further bug-related data gathering.

Moreover, for the manager of debug department to confirm the correctness of the debug operation, the result of the debug operation should be forwarded to the debug department manager state 50 when the debug engineer finishes the debug operation. Referring to the FIG. 5, the path 611 corresponding to the debug completing instruction 61 is altered to the path 612 pointing from the debug completing instruction 61 to the debug department manager state 50. It should be noted that this step could be performed by executing the steps of deleting the path 611 and then adding the path 612.

Secondly, a completion confirming instruction 53 is added in the debug department manager state 50, a work finishing state 70 is added, and a path 531 is then established. The path 531 points from the completion confirming instruction 53 to the work finishing state 70. In the embodiment, when the manager of the debug department confirms the correctness of the debug operation, the manager chooses to execute the completion confirming instruction 53. Thus, the message of confirming the completion of the debug request form is forwarded to the work finishing state 70.

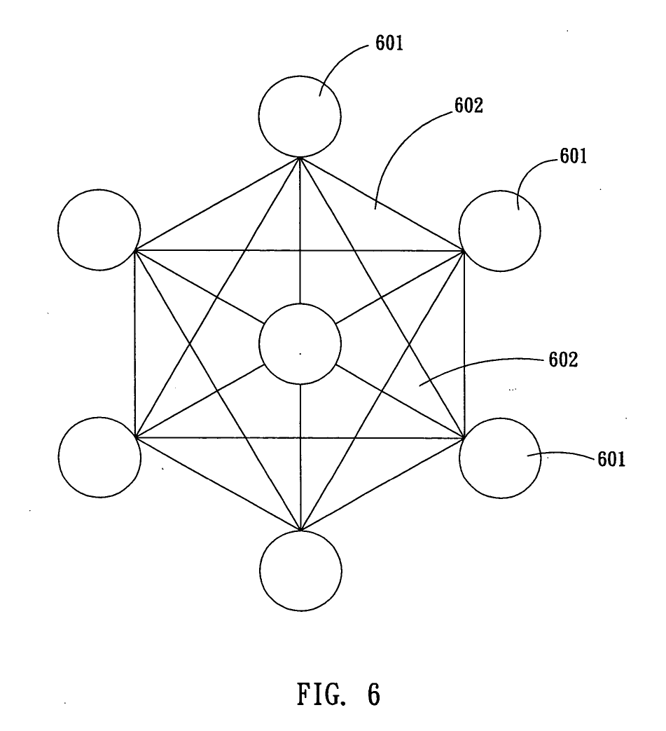

Apparently, as shown in FIG. 6, the spirit of the invention can be extracted as to be the establishment of a plurality of paths 602 between the states 601. The key points are the relationship between the states 601 and the instructions, and how the states 601 are linked using the instructions and the paths 602.

Furthermore, the advantage of the invention can be realized by comparing the differences between FIG. 1A and FIG. 1B, and the differences between FIG. 4 and FIG. 5. For example, except for the addition of the work finishing state 70 in view of the new workflow, the basic architecture of the invention still comprises the report generating state 40, the debug department manager state 50, and the debug engineer state 60. The workflow can be easily revised by simply change some instructions and some paths between the instructions and the paths. Comparatively, in the conventional technique, one must add some new steps and arrange the contents and paths of each step, which makes the conventional technique more complicated and inefficient. For example, the invention can arrange the states to make it correspond to the structure of the company, so that each department can control its job more easily. Comparatively, when revising the workflow, according to the conventional technique, one always has to change the job of each department accordingly. This makes the workflow revision process more fragmentary, and data tend to be lost during the workflow revision process.

In the present embodiment, the work finishing state 70 is cooperated with the report generating department for the personnel of the report generating department to determine whether to conclude the debug request form according to the information of the work finishing state 70. The personnel of the report generating department can also determine that the debug result in under expectation to start the debug workflow again. As shown in FIG. 5, the work finishing state 70 comprises a re-starting instruction 71, which points to the debug department manager state 50 via the path 711. Therefore, when the debug operation result does not meet the expectation of the report generating department, the personnel of the report generating department would choose to execute the re-starting instruction 71 to send this message to the debug department manager state 50 for the manager of the debug department to examine whether the bug-related data is sufficient or whether other problem exists. In the present embodiment, the personnel of the report generating department may input new data into the report generating state 40 or the work finishing state 70, the manager of the debug department may input new data into the debug department manager state 50, and the debug engineer can input new data into the debug engineer state 60.

As mentioned previously, after the workflow being revised, since the terminal states constituting the main architecture of the debug workflow remain the same, the problems of data loss and data compatibility before and after the workflow revision would not exist. Besides, because the various terminal states remain the same, the modification of the whole workflow is basically the revising of the contents of each terminal state and the correction of the relationships between the terminal states. The concept is similar to the module program and greatly simplifies the revises and the maintenances of the workflow. For instance, after generating the re-signing instruction 62, the data existing in the debug engineer state 60 before generating the re-signing instruction 62 can be used to perform the re-signing procedure, which is similar to dynamic changing the dataflow.

Furthermore, the present invention also provides a recording medium that records a computer readable and executable workflow managing program. The program comprises a state setting program code segment, an instruction generating program code segment, and a path generating program code segment. In the embodiment, the state setting program code segment is for the computer to set terminal states, such as the report generating state 40, the debug department manager state 50, and the debug engineer state 60, and the likes. The instruction generating program code segment is for the computer to generate the instructions, such as the sending instruction 41, the receiving instruction 51, the returning instruction 52, the debug completing instruction and the likes. The path generating program code segment is for the computer to generate paths, such as the path 411, the path 511, the path 521, the path 611 and the likes. Besides, the workflow managing program might further comprise at least one of the following: a state adding program code segment, an instruction adding program code segment, a path altering program code segment, a path deleting program code segment, an instruction receiving program code segment and a data adding program code segment to control the workflow as effectively as the debug operation procedure mentioned previously. The detailed descriptions about the above procedures are the same as those previously described, therefore they are omitted herein for concise purpose.

To sum up, the workflow managing method of the invention sets different terminal states as the framework of the workflow. Each terminal state has at least one instruction, and each instruction has its own corresponding path(s). Therefore, it is easier to control the workflow and the progress of the work or data. Besides, the workflow managing method of the invention uses the steps of adding/deleting the terminal states, adding/deleting the instructions thereof, and correcting the paths in correspondence with each instruction so as to modify and maintain the original mainframe of the terminal state. Thus, the data can be integrated without any loss.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A workflow managing method, comprising:
at least setting a first terminal state, a second terminal state, and a third terminal state;
at least generating a first instruction, a second instruction, and a third instruction for the first terminal state, the second terminal state, and the third terminal state, respectively; and
generating a first path, a second path, and a third path respectively according to the first instruction, the second instruction, and the third instruction, wherein the first path, the second path and the third path respectively points from the first instruction, the second instruction and the third instruction to one of the first terminal state, the second terminal state and the third terminal state.

2. The workflow managing method according to claim 1, wherein:
data of the first terminal state are output from the first terminal state via the first path when the first instruction is executed;
data of the second terminal state are output from the second terminal state via the second path when the second instruction is executed; and
data of the third terminal state are output from the third terminal state via the third path when the third instruction is executed.

3. The workflow managing method according to claim 2, wherein:
one of the first instruction, the second instruction and the third instruction points from the corresponding terminal state to at least two of the first terminal state, the second terminal state and the third terminal state.

4. The workflow managing method according to claim 1, further comprising:
adding a fourth terminal state;
generating a fourth instruction for the fourth terminal state; and
generating a fourth path according to the fourth instruction, wherein the fourth path points from the fourth instruction to at least one of the first terminal state, the second terminal state, the third terminal state, and the fourth terminal state.

5. The workflow managing method according to claim 1, further comprising:
generating a fifth instruction for one of the first terminal state, the second terminal state and the third terminal state; and
generating a fifth path according to the fifth instruction, wherein the fifth path points from the fifth instruction to at least one of the first terminal state, the second terminal state and the third terminal state.

6. The workflow managing method according to claim 1, further comprising:
altering one of the first path, the second path and the third path to point to another one of the first terminal state, the second terminal state and the third terminal state.

7. The workflow managing method according to claim 1, further comprising:
altering one of the first path, the second path and the third path to point to another two of the first terminal state, the second terminal state and the third terminal state.

8. The workflow managing method according to claim 1, further comprising:
deleting one of the first path, the second path and the third path.

9. The workflow managing method according to claim 1, which cooperates with at least one user, wherein the user selected from the first terminal state, the second terminal state, or the third terminal state to execute the first instruction, the second instruction or the third instruction.

10. The workflow managing method according to claim 9, wherein the user further inputs added data to one of the first terminal state, the second terminal state, and the third terminal state.

11. A recording medium storing a computer readable and executable program for performing a workflow managing method, the program comprising:
a state setting program code segment, which is computer-readable to at least set a first terminal state, a second terminal state, and a third terminal state;
an instruction generating program code segment, which is computer-readable to at least generate a first instruction, a second instruction, and a third instruction for the first terminal state, the second terminal state, and the third terminal state, respectively; and
a path generating program code segment, which is computer-readable to generate a first path, a second path, and a third path respectively according to the first instruction, the second instruction, and the third instruction, wherein the first path, the second path and the third path respectively point from the first instruction, the second instruction and the third instruction to one of the first terminal state, the second terminal state and the third terminal state.

12. The recording medium of claim 11, wherein:
data of the first terminal state are output from the first terminal state via the first path when the first instruction is executed;
data of the second terminal state are output from the second terminal state via the second path when the second instruction is executed; and
data of the third terminal state are output from the third terminal state via the third path when the third instruction is executed.

13. The recording medium of claim 11, wherein:
one of the first instruction, the second instruction and the third instruction points from the corresponding terminal state to at least two of the first terminal state, the second terminal state and the third terminal state.

14. The recording medium of claim 11, wherein the program further comprises:
a state adding program code segment, which is computer-readable to add a fourth terminal state, wherein the instruction generating program code segment is computer-readable to generate a fourth instruction for the fourth terminal state, the path generating program code segment is computer-readable to generate a fourth path according to the fourth instruction, and the fourth path points from the fourth instruction to at least one of the first terminal state, the second terminal state, the third terminal state, and the fourth terminal state.

15. The recording medium of claim 11, wherein the program further comprises:
an instruction adding program code segment, which is computer-readable to generating a fifth instruction for one of the first terminal state, the second terminal state and the third terminal state, wherein the path generating program code segment is computer-readable to generate a fifth path according to the fifth instruction, and the fifth path points from the fifth instruction to at least one of the first terminal state, the second terminal state and the third terminal state.

16. The recording medium of claim 11, wherein the program further comprises:
a path altering program code segment, which is computer-readable to alter one of the first path, the second path and the third path to point to another one of the first terminal state, the second terminal state and the third terminal state.

17. The recording medium of claim 11, wherein the program further comprises:
a path altering program code segment, which is computer-readable to alter one of the first path, the second path and the third path to point to another two of the first terminal state, the second terminal state and the third terminal state.

18. The recording medium of claim 11, wherein the program further comprises:
a path deleting program code segment, which is computer-readable to delete one of the first path, the second path and the third path.

19. The recording medium of claim 11, wherein the program further comprises:
an instruction receiving program code segment, which is computer-readable to receive the first instruction, the second instruction or the third instruction that a user selected from the first terminal state, the second terminal state, or the third terminal state.

20. The recording medium of claim 19, wherein the program further comprises:
a data adding program code segment, which is computer-readable to allow the user to input added data to one of the first terminal state, the second terminal state, and the third terminal state.
